(19) United States
(12) Patent Application Publication
(10) Pub. No.: US 2001/0043991 A1
(43) Pub. Date: Nov. 22, 2001

(54) METHOD AND APPARATUS FOR APPLYING SYNTACTIC FOAM THERMAL INSULATION TO A LENGTH OF PIPE

(76) Inventor: LOU W. WATKINS, STOUGHTON, MA (US)

Correspondence Address: SAMUELS GAUTHIER & STEVENS LLP, 225 FRANKLIN STREET, SUITE 3300, BOSTON, MA, 02110

(21) Appl. No.: 09/464,997

(22) Filed: Dec. 16, 1999

Related U.S. Application Data
(60) Provisional application No. 60/112,470, filed on Dec. 16, 1998.

(51) Int. Cl. B05D 3/12; B29C 47/12

(52) U.S. Cl. 427/358; 427/243; 427/247; 425/461

(57) ABSTRACT

An inner syntactic foam insulator and an outer protective cover are co-extruded around a length of pipe. The protective cover is then rapidly solidified to retain the syntactic foam insulator in a desired shape about the length of pipe. The protective cover is preferably a thermoplastic or a thermosetting material. One technique for rapidly solidifying the thermoplastic protective cover is to bring the protective cover into contact with a liquid coolant (e.g., water). A thermosetting protective cover is rapidly solidified by heating the cover. According to another aspect of the invention, an inner syntactic foam insulator and an outer protective cover are co-extruded to provide an apparatus comprising the inner syntactic foam insulator encased by the outer protective cover. Advantageously, rapidly solidifying the protective layer provides a hard outer layer that protects the syntactic foam insulator as the insulator cures.

### CROSS REFERENCE TO RELATED APPLICATIONS

This application claims priority from the provisional application designated serial number 60/112,470 filed Dec. 16, 1998 and entitled “Method for Molding and Applying Syntactic Foam Thermal Insulation to Pipelines”. This application is hereby incorporated by reference.

### BACKGROUND OF THE INVENTION

The invention relates to the field of insulated pipelines, and in particular to a method and apparatus for co-extruding an insulating material that is encased within a thermoplastic or thermosetting protective cover.

The resistance to flow of liquid products such as oil increases as temperature decreases. This problem can be reduced by using thermally insulated pipelines. However, for offshore pipelines it has usually been more cost effective to reduce the need for insulation by injecting various chemicals into the product.

More and more oil and gas is being recovered in deeper, colder water, from subsea production systems where use of viscosity reducing chemicals requires a dedicated line to transport them to the wellhead. This, combined with the fact that the cost of insulating pipelines typically increases with depth, indicates that insulated pipelines are most expensive where the alternatives are least attractive.

Prior art insulation used in undersea pipelines include porous plastic foam, such as polyurethane foam. As known, the lower the density of this insulating material, the higher percentage of air within the material, and therefore the more efficient it is as an insulator. However, as the insulating ability of the material increases due to decreased density, the weaker the material becomes. Specifically, as the density decreases so does the depth at which the foam cellular structure can operate in. Generally, prior art insulators fail in a few hundred feet of water due to the hydrostatic pressure on the insulation. So the design tradeoff comes down to how light an insulator can be placed onto the surface of the pipe and have it withstand the hydrostatic pressure and other stresses, and at the same time provide the necessary thermal insulation for a long period of time.

These prior art insulators worked in the past because the operational depth of the pipeline was rather shallow. However, the oil industry has undergone a vary rapid movement into deeper water. Several years ago the deepest producing oil well was in approximately fifteen hundred feet of water. The deepest oil well producing today is in four thousand feet of water. The deepest producing oil well planned for two years from today is in ten thousand feet of water. Significantly, as the operating depth increases these relatively lightweight, low cost, low strength prior art materials become unsuitable. Specifically, the materials can no longer withstand the hydrostatic pressure and become saturated with water, thus undesirably becoming a thermal conductor rather than an insulator.

The use of syntactic foams has been discussed as an insulator suitable for deep-sea pipeline insulation. As known, syntactic foams are composite materials in which hollow structures, such as microspheres are dispersed in a resin matrix.

A conventional technique for manufacturing an insulated length of pipe is to cast the syntactic foam insulating material directly onto the length of pipe. Casting is effective because the materials are rigidly contained inside a mold and held in intimate contact with the pipe for whatever length of time is required for the syntactic foam to cure. A problem with this technique is that it is not adaptable to high volume production because you have to have a number of molds, and sufficient floor space is required to store the populated molds so the mold is not disturbed as the syntactic foam cures inside.

Therefore, there is a need for an improved technique for manufacturing insulated lengths of pipe.

### SUMMARY OF THE INVENTION

Briefly, according to the present invention, an inner syntactic foam insulator and an outer protective cover are co-extruded around a length of pipe. The protective cover is then rapidly solidified to retain the syntactic foam insulator in a desired shape about the length of pipe.

The protective cover is preferably a thermoplastic or a thermosetting material. One technique for rapidly solidifying the thermoplastic protective cover is to bring the protective cover into contact with a liquid coolant (e.g., water). A thermosetting protective cover is rapidly solidified by heating the cover.

According to another aspect of the invention, an inner syntactic foam insulator and an outer protective cover are co-extruded to provide a product comprising the inner syntactic foam insulator encased by the outer protective cover.

Advantageously, rapidly solidifying the protective layer provides a hard outer layer that protects the syntactic foam insulator as the insulator cures.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 illustrates a length of pipe being passed through an extruder that coextrudes syntactic foam and a protective coating about the length of pipe;

FIG. 2 is a cross-sectional illustration of a length of pipe following co-extrusion;

FIG. 3 is illustrates an alternative embodiment extruder that encases syntactic foam with a protective cover;

FIG. 4 is a cross-sectional illustration of a product comprising an inner syntactic foam insulator encased by a protective layer; and

FIG. 5 is a cross-sectional illustration of the product illustrated in FIG. 4 placed into a mold to reshape the apparatus.

### DETAILED DESCRIPTION OF THE INVENTION

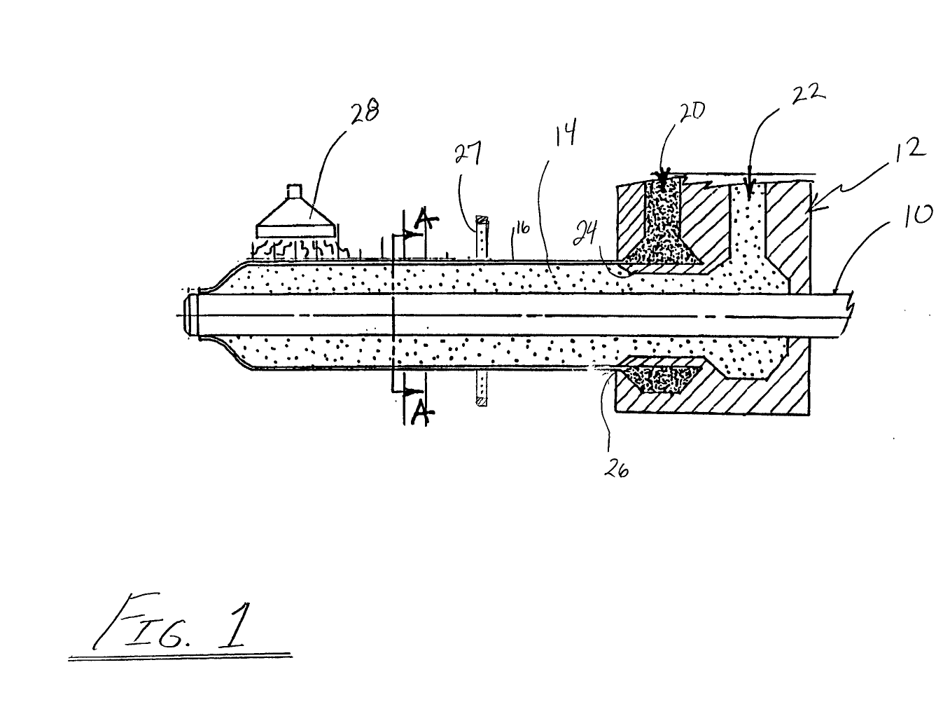

FIG. 1 illustrates a length of pipe 10 being passed through an extruder 12, which coextrudes a syntactic foam insulator 14 and a protective coating 16 around the length of pipe 10. The length of pipe may be steel and have a diameter of about 4 to 6 inches. The pipe is often referred to as a “flow line” because oil or gas, or in most cases a combination of the two pass through the pipe.

The extruder 12 includes a first material inlet 20 that receives a molten protective coating and a second inlet 22 that receives a syntactic foam insulator mixture. The temperature of the molten protective coating is approximately 300°-400° F., while the syntactic foam insulator mixture is at room temperature. The insulator mixture and the molten protective coating are both injected under pressure through dies 24, 26 respectively. The dies 24, 26 are preferably cylindrical, which is the shape of the pipe shown in FIG. 1. The molten protective coating is preferably a thermoplastic (e.g., polyethylene, polypropylene, etc.) or a thermosetting material (e.g., a plastic resin).

Following the coextrusion of the syntactic foam insulator 14 and the protective coating 16, the protective coating is rapidly solidified. Notably, rapidly solidifying the protective coating provides a shell that retains the syntactic foam insulator in a desired cross sectional shape (e.g., cylindrical) while the insulator cures.

To rapidly solidify a thermoplastic protective coating, the protective coating is cooled with a liquid coolant (e.g., water). This may be performed by passing the length of pipe with the extruded foam insulator and the protective coating through a liquid coolant spray. The spray may be provided from a circular spray nozzle 27 through which the coated length of pipe passes. Alternatively, the length of pipe coated with the extruded insulator and the protective coating may be immersed in a liquid coolant bath (not shown) to cool and solidify the thermoplastic protective coating. One of ordinary skill will recognize that there are other techniques for rapidly solidifying a thermoplastic protective coating. For example, it is contemplated that air cooling (e.g., forced air cooling) may also be used to rapidly solidify the protective layer.

To rapidly solidify a thermosetting protective coating, the protective coating 16 is heated. The heating may be performed by a radiant or microwave heating source 28 as shown in FIG. 1.

Following the rapid solidification of the protective layer 16, the syntactic foam insulator 14 is cured. The curing process may be sped up by heating the foam mixture with a radiant or microwave heating device. Of course, the amount of heat applied to increase the insulator cure rate can not be so great as to harm the protective coating 16. In general, it typically takes several hours to cure the syntactic foam insulator. For example, it may take about six hours to cure the syntactic foam insulator. In a preferred embodiment it is contemplated that the syntactic foam insulator mixture will be selected for increased strength, rather than for rapid cure.

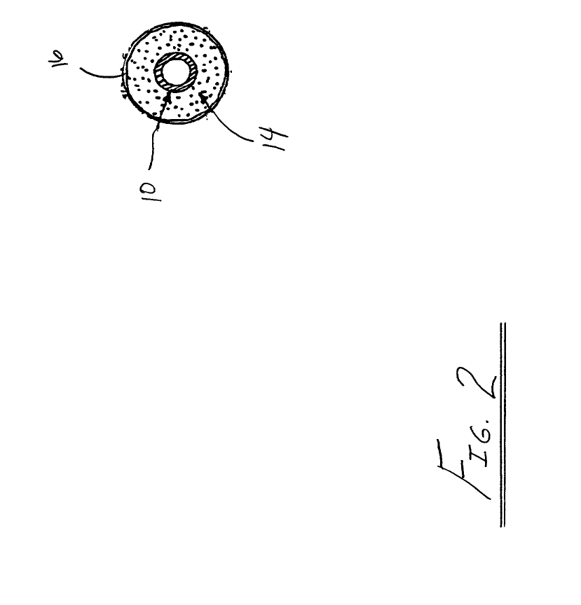

FIG. 2 is a cross sectional illustration of the insulated length of pipe. One of ordinary skill will recognize that the thicknesses may not be to scale, and are selected primarily for ease of illustration.

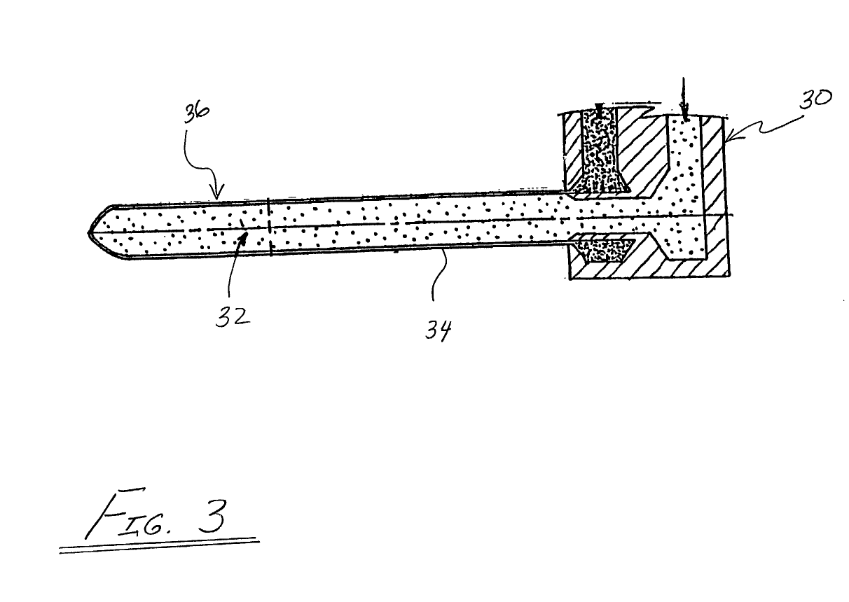

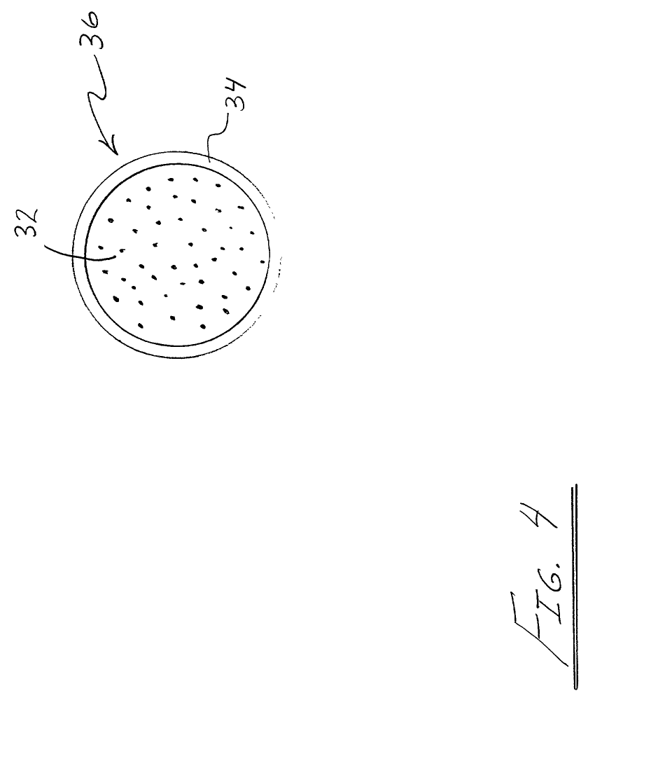

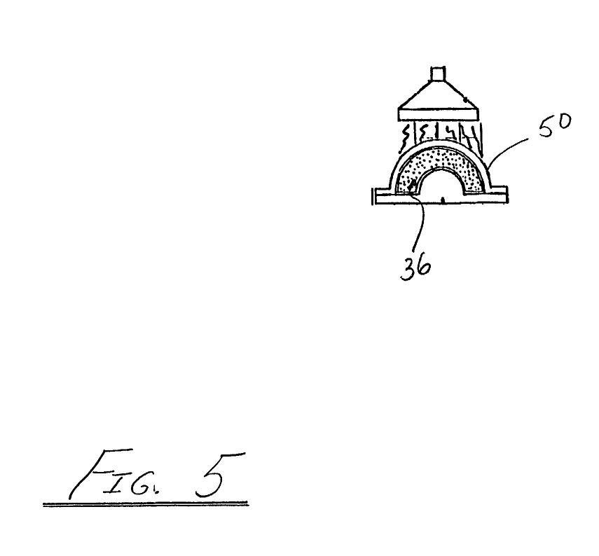

FIG. 3 illustrates an alternative embodiment co-extrusion technique. Extruder 30 coextrudes an inner syntactic foam insulator 32 and a outer protective cover 34 (e.g., thermoplastic material, thermosetting material, etc.) to provide a product 36 (e.g., cylindrical) comprising the inner syntactic foam insulator 32 encased by the outer protective cover 34. FIG. 4 illustrates a cross sectional view of the resulting product 36. The syntactic foam insulator 32 and the outer protective cover 34 are similar to the associated elements illustrated in FIGS. 1 and 2. Advantageously, the product 36 can be used as a preform suitable for subsequent re-shaping into a variety of custom shapes. For example, the product 36 may be preformed and the syntactic foam allowed to cure, and at a later time the apparatus is re-heated and placed into a mold for reshaping. Specifically, FIG. 5 illustrates the product 36 (re-heated) placed into a mold 50 for reshaping. Once the product 36 is placed into the mold the protective outer layer is re-hardened. It is also contemplated that the product may be placed into a shallow mold and allowed to settle out to form an insulating tape.

Although the present invention in one aspect has discussed coextruding the syntactic foam insulator and the protective layer onto a cylindrical pipe, it is contemplated that non-cylindrical pipes/flow lines may also be treated according to the present invention. In addition, although certain temperature and curing time has been mentioned by way of example, the exact numbers may vary depending upon the characteristics of the selected syntactic foam and protective layer.

Although the present invention has been shown and described with respect to several preferred embodiments thereof, various changes, omissions and additions to the form and detail thereof, may be made therein, without departing from the spirit and scope of the invention.

What is claimed is:

1. A method of applying syntactic foam insulation to a length of pipe, said method comprising the steps of:
co-extruding an inner syntactic foam insulator and an outer protective cover around the length of pipe; and
rapidly solidifying said protective cover to retain said syntactic foam insulator in a desired shape about the length of pipe.

2. The method of claim 1, wherein said protective cover comprises a thermoplastic material.

3. The method of claim 1, wherein said protective cover comprises a thermosetting material.

4. The method of claim 1, wherein said step of rapidly solidifying comprises the step of bringing said protective cover in contact with water to cool said protective cover.

5. The method of claim 2, wherein said step of rapidly solidifying comprises the step of passing the coated length of pipe through a liquid bath to cool said protective cover.

6. The method of claim 4, wherein said protective cover comprises a thermoplastic.

7. The method of claim 5, wherein said protective cover comprises a thermosetting material and said step of rapidly solidifying includes a step of applying heat to said thermosetting material to solidify said thermosetting material.

8. The method of claim 2, wherein said step of rapidly solidifying comprises the step of air cooling said thermoplastic material.

9. A method of forming an insulating product, said method comprising the steps of:
co-extruding an inner syntactic foam insulator and an outer protective cover; and
rapidly solidifying said protective cover.

10. The method of claim 9, wherein said outer protective cover is a thermoplastic and said step of rapidly solidifying comprises the step of cooling said cover with a liquid coolant.

11. The method of claim 9, wherein said outer protective cover is a thermosetting material and said step of rapidly solidifying comprises the step of applying heat to said thermosetting material.

12. The method of claim 9, wherein said outer protective cover is a thermoplastic and said step of rapidly solidifying comprises the step of air cooling said cover.

13. An extruder for forming an insulating material, comprising:
a first inlet that receives a syntactic foam mixture;
a second inlet that receives a molten protective cover;
a first die through which said syntactic foam mixture exits to provide extruded syntactic foam extrudate; and
a second die that cooperates with said first die to coextrude said molten protective cover over said extruded syntactic foam extrudate.

14. The extruder of claim 13, wherein said extruder further comprises a third inlet through which a length of pipe enters the extruder, wherein said first and second dies coextrude said syntactic foam extrudate and said protective cover extrudate over said inner length of pipe.

15. The extruder of claim 12, further comprises:
means for rapidly solidifying said protective cover extrudate following its extrusion over said syntactic foam.

16. The extruder of claim 14, wherein said protective cover extrudate comprises a thermoplastic material and said means for rapidly solidifying said protective cover comprises means for providing a liquid coolant to rapidly solidify said protective cover.

17. The extruder of claim 14, wherein said protective cover extrudate comprises a thermosetting material and said means for rapidly solidifying said protective cover comprises a heat source to rapidly solidify said protective cover.
